(19) United States
(12) Patent Application Publication
(10) Pub. No.: US 2018/0248759 A1
(43) Pub. Date: Aug. 30, 2018

(54) TROUBLESHOOTING IN REMOTE MANAGEMENT SERVICES

(71) Applicants: Bahadir Danisik, Austin, TX (US); Jigang Yang, Cedar Park, TX (US); Artyom Sivkov, Brussels (BE)

(72) Inventors: Bahadir Danisik, Austin, TX (US); Jigang Yang, Cedar Park, TX (US); Artyom Sivkov, Brussels (BE)

(73) Assignees: Alcatel-Lucent USA Inc., Murray Hill, NJ (US); Alcatel-Lucent Bell N.V., Antwerp (BE)

(21) Appl. No.: 15/444,172

(22) Filed: Feb. 27, 2017

(51) Int. Cl. H04L 12/24

(52) U.S. Cl. CPC H04L 41/0886; H04L 41/24

(57) ABSTRACT

The present disclosure generally discloses improvements in computer performance for supporting troubleshooting in a remote management service (RMS) based on an RMS troubleshooting capability. The RMS troubleshooting capability may be configured to enable troubleshooting within the context of an RMS configured to support remote management of a managed device(s) by a managing device(s). The RMS troubleshooting capability may be configured to support troubleshooting for an RMS by isolating traffic of managed devices for which troubleshooting is not being performed (e.g., which traffic is directed to managing devices of the RMS) from traffic of managed devices for which troubleshooting is being performed (e.g., which traffic is directed to troubleshooting devices of the RMS). The RMS troubleshooting capability may be configured to support troubleshooting for an RMS by directing traffic of a managed device to a troubleshooting server, rather than to a managing device (e.g., a device management server), under various conditions.

### TECHNICAL FIELD

The present disclosure relates generally to communication networks and, more particularly but not exclusively, to improvements in computer performance for supporting troubleshooting in remote management services.

### BACKGROUND

Remote management services may be used for remote management of devices. For example, one popular type of remote management service for remote device management is the Automatic Configuration Service, which enables Automatic Configuration Servers (ACSs) to perform remote device management of customer premises equipment (CPE) and network equipment. While such remote management services may enable efficient management of devices remotely, many such remote management services may struggle to support problem handling in production environments.

### SUMMARY

The present disclosure generally discloses improvements in computer performance for supporting troubleshooting for a remote management service.

In at least some embodiments, an apparatus is provided. The apparatus is configured to support troubleshooting in a remote management service. The apparatus includes a processor and a memory communicatively connected to the processor. The processor is configured to receive, by a load balancer for the remote management service from a managed device, a message intended for the remote management service. The processor is configured to send, by the load balancer toward a troubleshooting server based on a determination by the load balancer that the managed device is included in a list of managed devices for which troubleshooting functions are to be performed, the message intended for the remote management service. In at least some embodiments, a non-transitory computer-readable storage medium stores instructions which, when executed by a computer, cause the computer to perform a corresponding method for supporting troubleshooting for a remote management service. In at least some embodiments, a corresponding method for supporting troubleshooting for a remote management service is provided.

In at least some embodiments, an apparatus is provided. The apparatus is configured to support troubleshooting in a remote management service. The apparatus includes a processor and a memory communicatively connected to the processor. The processor is configured to receive, by a troubleshooting server from a load balancer associated with the remote management service, a message of a managed device associated with the remote management service. The processor is configured to perform, by the troubleshooting server based on the message, a troubleshooting function for the managed device associated with the remote management service. In at least some embodiments, a non-transitory computer-readable storage medium stores instructions which, when executed by a computer, cause the computer to perform a corresponding method for supporting troubleshooting for a remote management service. In at least some embodiments, a corresponding method for supporting troubleshooting for a remote management service is provided.

In at least some embodiments, an apparatus is provided. The apparatus is configured to support troubleshooting in a remote management service. The apparatus includes a processor and a memory communicatively connected to the processor. The processor is configured to send, by a managing device of the remote management service toward a load balancer associated with the remote management service, a message including an indication that a troubleshooting function is to be performed for a managed device associated with the remote management service. The processor is configured to send, by the managing device toward the managed device, a connection request configured to trigger the managed device to send a message to the remote management service. In at least some embodiments, a non-transitory computer-readable storage medium stores instructions which, when executed by a computer, cause the computer to perform a corresponding method for supporting troubleshooting for a remote management service. In at least some embodiments, a corresponding method for supporting troubleshooting for a remote management service is provided.

In at least some embodiments, an apparatus is provided. The apparatus is configured to support troubleshooting in a remote management service. The apparatus includes a processor and a memory communicatively connected to the processor. The processor is configured to send, by a managed device toward a load balancer associated with the remote management service, a message intended for the remote management service. The processor is configured to receive, by the managed device from a troubleshooting server associated with the remote management service, a troubleshooting message associated with troubleshooting of the managed device. In at least some embodiments, a non-transitory computer-readable storage medium stores instructions which, when executed by a computer, cause the computer to perform a corresponding method for supporting troubleshooting for a remote management service. In at least some embodiments, a corresponding method for supporting troubleshooting for a remote management service is provided.

### BRIEF DESCRIPTION OF THE DRAWINGS

The teachings herein can be readily understood by considering the following detailed description in conjunction with the accompanying drawings, in which:

FIG. 1 depicts an example communication system configured to support troubleshooting for a remote management service;

FIG. 2 depicts an example process, within the context of the example communication system of FIG. 1, for supporting troubleshooting for a remote management service;

FIG. 3 depicts an embodiment of a method for use by a load balancer to support troubleshooting for a remote management service;

FIG. 4 depicts an embodiment of a method for use by a troubleshooting server to support troubleshooting for a remote management service;

FIG. 5 depicts an embodiment of a method for use by a device management server to support troubleshooting for a remote management service;

FIG. 6 depicts an embodiment of a method for use by a managed device to support troubleshooting for a remote management service; and

FIG. 7 depicts a high-level block diagram of a computer suitable for use in performing various functions presented herein.

To facilitate understanding, identical reference numerals have been used, where possible, to designate identical elements that are common to the figures.

### DETAILED DESCRIPTION

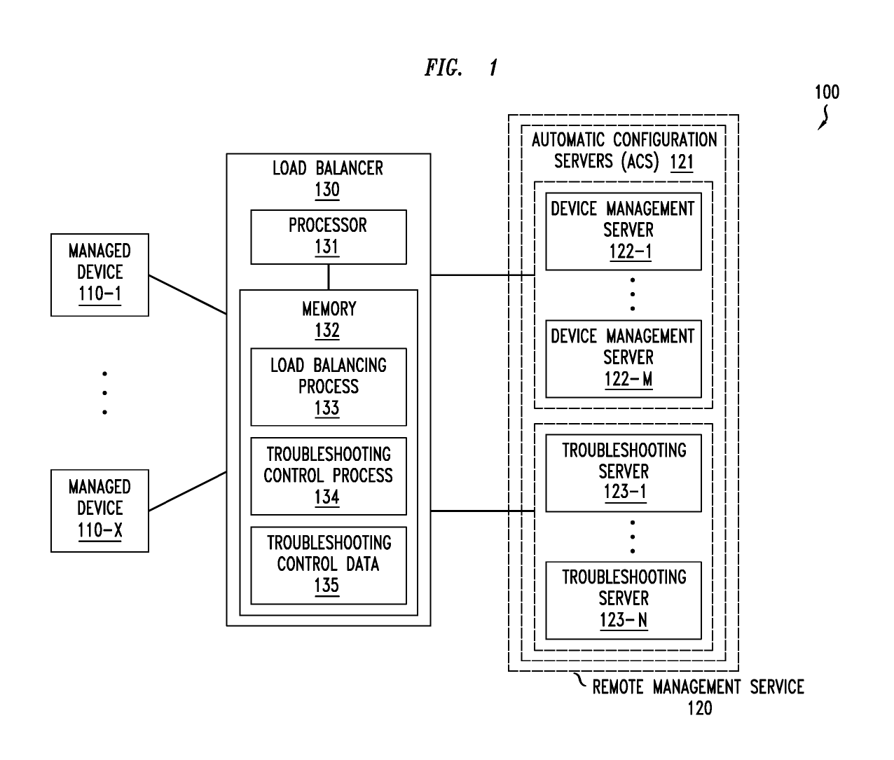

The present disclosure generally discloses improvements in computer performance for supporting troubleshooting for a remote management service (RMS) based on an RMS troubleshooting capability. The RMS troubleshooting capability may be configured to enable troubleshooting within the context of an RMS configured to support remote management of a managed device(s) by a managing device(s). The RMS troubleshooting capability may be configured to support troubleshooting for an RMS by supporting troubleshooting for a managed device that is having an issue or potential issue (e.g., functionality, interoperability, compatibility, or the like), supporting troubleshooting for a managing device having an issue or potential issue, or the like, as well as various combinations thereof. The RMS troubleshooting capability may be configured to support troubleshooting for an RMS by isolating traffic of managed devices for which troubleshooting is not being performed (e.g., which traffic is directed to managing devices of the RMS) from traffic of managed devices for which troubleshooting is being performed (e.g., which traffic is directed to troubleshooting device of the RMS). The RMS troubleshooting capability may be configured to support troubleshooting for an RMS by directing traffic of a managed device to a troubleshooting server (e.g., a trace server, a debug server, or other suitable troubleshooting server), rather than to a managing device (e.g., a device management server), under various conditions. The RMS troubleshooting capability may be configured to support troubleshooting for an RMS within a production environment, thereby obviating the need for having an identical pre-production environment for use in troubleshooting issues or potential issues and, similarly, obviating the need to use an identical pre-production environment for use in troubleshooting issues or potential issues when often times a problem seen in the production environment is not seen in an identical pre-production environment and cannot be (or is at least difficult to) reproduce in an identical pre-production environment. The RMS for which the RMS troubleshooting capability is provided may be an Automatic Configuration Service, which enables Automatic Configuration Servers (ACSs) to perform remote device management of customer premises equipment (CPE) and which typically uses the TR-069 protocol for remote management of CPEs by the ACSs, and is primarily presented herein with this context; however, it will be appreciated that various embodiments of the RMS troubleshooting capability may be adapted for use with other types of RMSs. It will be appreciated that these and various other embodiments and potential advantages of the RMS troubleshooting capability may be further understood by way of reference to the example communication system of FIG. 1.

FIG. 1 depicts an example communication system configured to support troubleshooting for a remote management service.

The communication system 100 includes a set of managed devices (MDs) 110-1-110-X (collectively, MDs 110), a remote management service (RMS) 120, and load balancer (LB) 130.

The MDs 110 are devices configured to be managed by the RMS 120. For example, the MDs 110 may be customer premises equipment (CPEs), network elements (NEs), or the like. The MDs 110 are communicatively connected to the LB 130 such that the MDs 110 may communicate with the RMS 120 (e.g., with devices configured to provide the RMS 120, as discussed further below) via the LB 130, although it is noted that the LB 130 may be transparent to the MDs 110. It will be appreciated the MDs 110 may be communicatively connected to the LB 130 via one or more communication networks (omitted for purposes of clarity, but which may include any communication networks configured to support communication between MDs 110 and LB 130, such as WiFi networks, cellular networks, optical networks, Ethernet networks, or the like, as well as various combinations thereof), which may depend on the service type of the RMS 120, the device types of the MDs 110 (e.g., CPE or NE), or the like, as well as various combinations thereof. The MDs 110, as discussed further below, may be configured to perform various functions in support of the RMS troubleshooting capability.

The RMS 120 is a remote management service configured to manage MDs 110. The RMS 120, as discussed further below, includes various devices configured to perform remote device management for the MDs 110. The RMS 120 (and, more specifically, the devices providing the RMS 120) is communicatively connected to the LB 130 such that the RMS 120 (again, the devices providing the RMS 120) may communicate with the MDs 110 via the LB 130. It will be appreciated the RMS 120 (again, the devices providing the RMS 120) may be communicatively connected to the LB 130 via one or more communication networks (omitted for purposes of clarity, but which may include any communication networks configured to support communication between RMS 120 and LB 130, which may depend on the service type of the RMS 120, the deployment locations of the RMS 120 and the LB 130, or the like, as well as various combinations thereof. The RMS 120, as discussed further below, may be configured to perform various functions in support of the RMS troubleshooting capability.

The RMS 120, in the example system 100 of FIG. 1, is assumed to be an automatic configuration service that is provided using a set of automatic configuration servers (ACSs) 121. The set of ACSs 121 includes a set of device management servers (DMSs) 122-1-122-M (collectively, DMSs 122) and a set of troubleshooting servers (TSs) 123-1-123-N (collectively, TSs 123).

The DMSs 122 of RMS 120 are ACSs that are configured to perform various device management functions for MDs 110. The device management functions supported by the DMSs 122 for the MDs 110 may include various device management functions typically performed by an ACS device management server based on TR-069, such as responding to messages from MDs 110, responding to instructions from the automatic configuration service, executing management actions (e.g., executing TR-069 Remote Procedure Calls (RPCs) such as GetParameterValues and SetParameterValues, downloading firmware or software to MDs 110, or the like), or the like, as well as various combinations thereof. The device management functions supported by the DMSs 122 for MDs 110 may be performed responsive to various events and conditions, such as responsive to messages from MDs 110 (e.g., TR-069 Inform messages, which may be triggered responsive to events like booting of MDs 110, bootstrapping of MDs 110, value changes of parameters of or for MDs 110, period scheduling events for MDs 110, or the like), responsive to requests by the automatic configuration service (e.g., bulk device management or other event-based mechanisms), responsive to requests by operations support systems (e.g., using the North Bound System (NBS) of ACS), or the like, as well as various combinations thereof. The device management functions typically performed by an ACS device management server, as well as the events and conditions which may trigger such device management functions to be performed by an ACS device management server, will be understood by one of ordinary skill in the art. The DMSs 122 may be dedicated devices (e.g., servers), virtual machines (VMs) configured to provide instances of the DMSs 122, or the like). The number M of DMSs 122 of the RMS 120 may depend on the number of MDs 110 being managed and frequency of management actions, and may be increased and decreased elastically (e.g., via instantiation and termination of VMs providing instances of the DMSs 122). The DMSs 122 are communicatively connected to the LB 130 and, as indicated above, may communicate with the MDs 110 via the LB 130. The DMSs 122, as discussed further below, may be configured to perform various functions in support of the RMS troubleshooting capability.

The TSs 123 of RMS 120 are ACSs that are configured to perform device troubleshooting functions for the MDs 110. The device troubleshooting functions supported by the TSs 123 may include trace functions, debugging functions, or the like, as well as various combinations thereof. The trace functions may include support for verbose level tracing, verbose logging, network traffic capture, or the like, as well as various combinations thereof. The debug functions may include support for enabling comprehensive debug settings, performing debugging for troubleshooting issues or potential issues based on the comprehensive debug settings, or the like, as well as various combinations thereof. The TSs 123 may be trace servers that are configured to perform trace functions for MDs 110, debug servers that are configured to perform debugging functions for MDs 110, other types of servers that are configured to perform other types of troubleshooting functions for MDs 110, or the like, as well as various combinations thereof. The TSs 123 may be dedicated devices (e.g., servers), virtual machines (VMs) configured to provide instances of the TSs 123, or the like). The number N of TSs 123 of the RMS 120 may depend on the number of MDs 110 being managed and frequency of management or troubleshooting actions (although it is expected, but not required, that the number N of TSs 123 of the RMS 120 will be less than the number M of DMSs 122 of the RMS 120, as not all MDs 110 are expected to need troubleshooting at the same time), and may be increased and decreased elastically (e.g., via instantiation and termination of VMs providing instances of the TSs 123). The TSs 123 are communicatively connected to the LB 130 and, as indicated above, may communicate with the MDs 110 via the LB 130. The TSs 123, as discussed further below, may be configured to perform various functions in support of the RMS troubleshooting capability.

The communication between the MDs 110 and the RMS 120, by which RMS 120 may provide automatic management functions for the MDs 110, may be based on any suitable management protocol. The management protocol may be an application layer protocol. In the example system 100 of FIG. 1, the RMS 120 is an automatic configuration service based on the sets of ACSs 121, where it will be understood that ACSs typically use the TR-069 protocol for remote management of CPEs (illustratively, the MDs 110). The TR-069 protocol is a technical specification, published by the Broadband Forum and entitled CPE WAN Management Protocol (CWMP), that defines an application layer protocol for remote management of devices, including end user devices and network device. It will be appreciated that, although primarily presented herein with respect to use of TR-069 as the management protocol by which the MDs 110 are remotely managed by the RMS 120, various other remote management protocols may be used.

The LB 130 is a load balancer configured to provide various functions for the RMS 120, including load balancing functions, troubleshooting control functions, or the like, as well as various combinations thereof. The LB 130 is configured to isolate traffic of MDs 110 for which troubleshooting is not being performed (e.g., which traffic is directed to DMSs 122 of the RMS 120) from traffic of MDs 110 for which troubleshooting is being performed (e.g., which traffic is directed to TSs 123 of the RMS 120). The LB 130 includes a processor 131 and a memory 132 that is communicatively connected to the processor 131. The memory 132 stores a load balancing process 133, a troubleshooting control process 134, and troubleshooting control data 135. The LB 130 may be implemented using one or more dedicated devices, one or more virtual machines (VMs), or the like.

The LB 130 is configured to provide load balancing functions for the RMS 120, thereby facilitating remote management of the MDs 110 by the RMS 120. The processor 131 is configured to execute the load balancing process 133 for enabling the LB 130 to perform load balancing functions for balancing load of MDs 110 across the DMSs 122 of the RMS 120. For example, the load balancing functions may include selection of DMSs 122 for new sessions of MDs 110, support for session stickiness for sessions of MDs 110 (e.g., once a session is established between an MD 110 and one of the DMSs 122, all communication of that session is between the MD 110 and the one of the DMSs 122). The load balancing functions typically performed by a load balancer for a remote management service such as the RMS 120 will be understood by one of ordinary skill in the art.

The LB 130 is configured to provide troubleshooting control functions for the RMS 120, thereby facilitating troubleshooting of the MDs 110 by the RMS 120. The processor 131 is configured to execute the troubleshooting control process 134, based on troubleshooting control data 135, to enable LB 130 to perform troubleshooting control functions for controlling troubleshooting of MDs 110 by TSs 123 of RMS 120.

The troubleshooting control process 134 may be configured to manage a list of MDs for which troubleshooting is to be performed, including controlling addition of MDs 110 to the list of MDs for which troubleshooting is to be performed and removing MDs 110 from the list of MDs for which troubleshooting is to be performed. The list of MDs for which troubleshooting is to be performed may be configured to identify the MDs 110 in various ways, such as by device identifiers of the MDs 110, addresses of the MDs 110, or the like, as well as various combinations thereof.

The troubleshooting control process 134 may be configured to add an MD 110 to the list of MDs for which troubleshooting is to be performed responsive to various events or conditions. For example, the troubleshooting control process 134 may be configured to add an MD 110 to the list of MDs for which troubleshooting is to be performed responsive to a determination by the LB 130 that troubleshooting of the MD 110 is necessary or desirable. For example, the troubleshooting control process 134 may be configured to add an MD 110 to the list of MDs for which troubleshooting is to be performed responsive to a message from the RMS 120, such as a message from a management system associated with the RMS 120 (e.g., a request, triggered automatically by the management system or manually by a user via a user interface of the management systems (e.g., an ACS user interface), for troubleshooting of the MD 110), a message from one of the DMSs 122 (e.g., a request by the DMS 122, which may triggered automatically or manually via a user interface associated with the DMSs 122, for troubleshooting of the MD 110), or the like. For example, the troubleshooting control process 134 may be configured to add an MD 110 to the list of MDs for which troubleshooting is to be performed responsive to a message from an operations support system (e.g., a request by the operations support system, which may triggered automatically or manually, for troubleshooting of the MD 110). The basis for triggering addition of an MD 110 to the list of MDs for which troubleshooting is to be performed may be an issue or potential issue with functionality of the MD 110, interoperability of the MD 110, compatibility of the MD 110, or the like, as well as various combinations thereof. The troubleshooting control process 134 may be configured to perform various other functions to control addition of an MD 110 to the list of MDs for which troubleshooting is to be performed.

The troubleshooting control process 134 may be configured to remove an MD 110 from the list of MDs for which troubleshooting is to be performed responsive to various events or conditions. For example, the troubleshooting control process 134 may be configured to remove an MD 110 from the list of MDs for which troubleshooting is to be performed responsive to a determination by the LB 130 that troubleshooting of the MD 110 is complete. For example, the troubleshooting control process 134 may be configured to remove an MD 110 from the list of MDs for which troubleshooting is to be performed responsive to a message from the RMS 120, such as a message from a management system associated with the RMS 120 (e.g., a message, triggered automatically by the management system or manually by a user via a user interface of the management systems (e.g., an ACS user interface), that troubleshooting of the MD 110 is complete), a message from one of the DMSs 122 (e.g., a message from the DMS 122, which may triggered automatically or manually via a user interface associated with the DMSs 122, indicative that troubleshooting of the MD 110 is complete), or the like. For example, the troubleshooting control process 134 may be configured to remove an MD 110 from the list of MDs for which troubleshooting is to be performed responsive to a message from an operations support system (e.g., a message of the operations support system, which may triggered automatically or manually, indicative that troubleshooting of the MD 110 is complete). The basis for triggering the removal of an MD 110 from the list of MDs for which troubleshooting is to be performed may be a resolution of an issue or potential issue with the MD 110. The troubleshooting control process 134 may be configured to perform various other functions to control removal of an MD 110 from the list of MDs for which troubleshooting is to be performed.

The troubleshooting control process 134 (or, more generally, the LB 130) may be configured to perform various other functions for managing the list of MDs for which troubleshooting is to be performed.

The troubleshooting control process 134 may be configured to control troubleshooting of MDs 110 based on the list of MDs for which troubleshooting is to be performed. The troubleshooting control process 134 may be configured to receive a message of an MD 110, identify the MD 110 based on the message of the MD 110 (e.g., an identifier of the MD 110 is included in the message of the MD 110, information included in the message of the MD 110 is used to identify the MD 110, or the like), determine whether the MD 110 is included in the list of MDs for which troubleshooting is to be performed, and handle the message of the MD 110 based on the determination as to whether the MD 110 is included in the list of list of MDs for which troubleshooting is to be performed. The troubleshooting control process 134, based on a determination that the MD 110 is not included in the list of MDs for which troubleshooting is to be performed, may pass the message of the MD 110 to the load balancing process 133 for handling (e.g., the message of the MD 110 is forwarded to one of the DMSs 122 of the RMS 120). The troubleshooting control process 134, based on a determination that the MD 110 is included in the list of MDs for which troubleshooting is to be performed, may forward the message of the MD 110 to one of the TSs 123 of the RMS 120 for troubleshooting of the MD 110 by the one of TSs 123. The forwarding of the message of the MD 110 to the one of the TSs 123 causes the one of the TSs 123 to perform troubleshooting for the MD 110, which may include various exchanges of messages between the one of the TSs 123 and the MD 110 (e.g., all of the communication of the MD 110 may be with the one of the TSs 123 until troubleshooting of the MD 110 is complete and the MD 110 is removed from the list of MDs for which troubleshooting is to be performed).

The LB 130 may be configured to provide various other types of functions for the RMS 120.

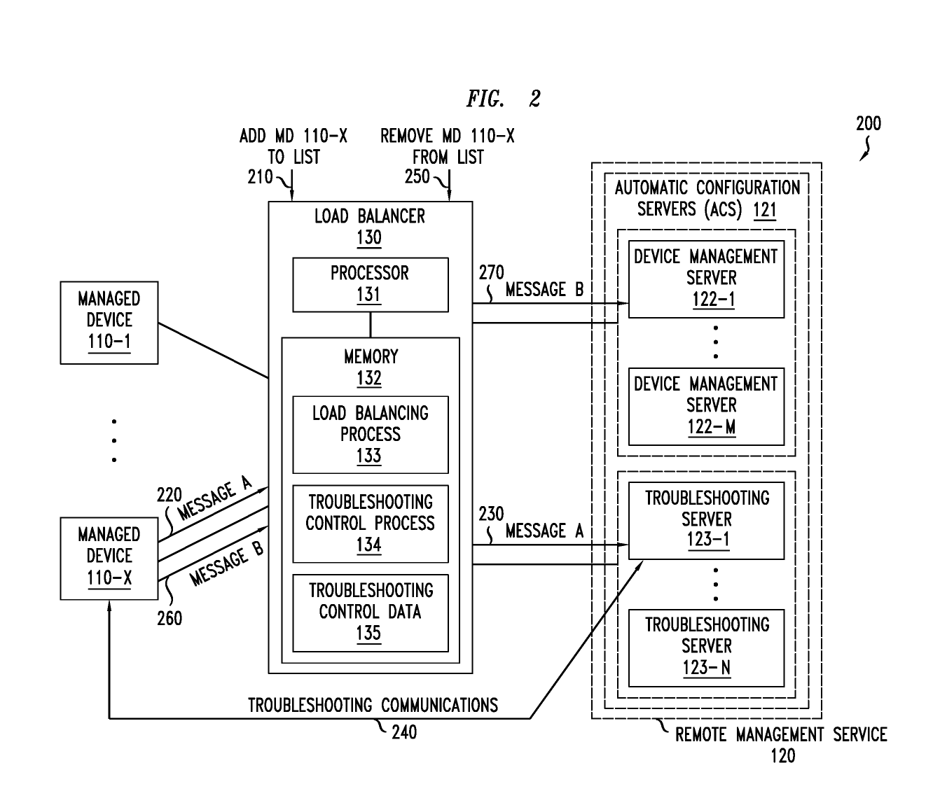

It is noted that the operation of various elements of system 100 of FIG. 1 in performing functions in support of the RMS troubleshooting capability may be further understood with respect to the example process presented with respect to FIG. 2.

FIG. 2 depicts an example process, within the context of the example communication system of FIG. 1, for supporting troubleshooting for a remote management service.

The process 200 of FIG. 2 is presented within the context of the communication system 100 of FIG. 1 and includes a set of steps which may be performed by elements of the communication system 100 of FIG. 1 for supporting troubleshooting of one of the MDs 110 (illustratively, in FIG. 2, MD 110-X).

At step 210, the LB 130 adds the MD 110-X to the list of MDs for which troubleshooting is to be performed. The LB 130 may add the MD 110-X to the list of MDs for which troubleshooting is to be performed responsive to a local determination by the LB 130. The LB 130 may add the MD 110-X to the list of MDs for which troubleshooting is to be performed responsive to a message received by the LB 130 (e.g., from RMS 120, from a DMS 122, from a TS 123, from an operations support system, or the like).

At step 220, the MD 110-X sends to the LB 130 a message (denoted as message A) intended for the RMS 120 (i.e., intended for handling by one of the DMSs 122 of the RMS 120). The message A may be a connection request, a management message, or the like. The MD 110-X may send the message A, which is intended for the RMS 120, to the LB 130 based on a need or desire by the MD 110-X to send the message A to the RMS 120 (e.g., the message A is sent the next time that the MD 110-X needs or wants to communicate with the RMS 120). The MD 110-X may send the message A, which is intended for the RMS 120, to the LB 130 based on receipt of a trigger from the RMS 120 (e.g., from one of the DMSs 122 of the RMS 120), which may be referred to as the RMS 120 (or the one of the DMSs 122 of the RMS 120) “kicking” the MD 110-X to trigger the activation of troubleshooting for the MD 110.

At step 230, the LB 130, based on a determination by the LB 130 that the MD 110-X from which the message is received is on the list of MDs for which troubleshooting is to be performed, sends the message A to one of the TSs 123 of the RMS 120 (illustratively, TS 123-1) rather than to one of the DMSs 122 of the RMS 120 to which it otherwise would have been sent.

At step 240, the TS 123-1 and the MD 110-X communicate for purposes of enabling the TS 123-1 to perform troubleshooting for the MD 110-X. The TS 123-1 and the MD 110-X may exchange various types of troubleshooting messages and associated troubleshooting information for purposes of enabling the TS 123-1 to perform troubleshooting for the MD 110-X. The troubleshooting messages may be exchanged via the LB 130, via a communication path that excludes the LB 130, or a combination thereof. The troubleshooting performed by the TS 123-1 based on communication with the MD 110-X may include verbose logging, debug processing, or the like, as well as various combinations thereof.

At step 250, the LB 130 removes the MD 110-X from the list of MDs for which troubleshooting is to be performed. The LB 130 may remove the MD 110-X from the list of MDs for which troubleshooting is to be performed responsive to a local determination by the LB 130. The LB 130 may remove the MD 110-X from the list of MDs for which troubleshooting is to be performed responsive to a message received by the LB 130 (e.g., from RMS 120, from a DMS 122, from the TS 123-1 which performed troubleshooting for MD 110-X, from an operations support system, or the like).

At step 260, the MD 110-X sends to the LB 130 a message (denoted as message B) intended for the RMS 120 (i.e., intended for handling by one of the DMSs 122 of the RMS 120). The message B may be a connection request, a management message, or the like. The MD 110-X may send the message B, which is intended for the RMS 120, to the LB 130 based on a need or desire by the MD 110-X to send the message B to the RMS 120 (e.g., the message B is sent the next time that the MD 110-X needs or wants to communicate with the RMS 120). The MD 110-X may send the message B, which is intended for the RMS 120, to the LB 130 based on receipt of a trigger from the RMS 120 (e.g., from one of the DMSs 122 of the RMS 120), such as where the RMS 120 has a need or desire to perform a device management function for the MD 110-X.

At step 270, the LB 130, based on a determination by the LB 130 that the MD 110-X from which the message is received is not on the list of MDs for which troubleshooting is to be performed, sends the message B to one of the DMSs 122 of the RMS 120 (illustratively, DMS 122-1) rather than to one of the TSs 123 of the RMS 120.

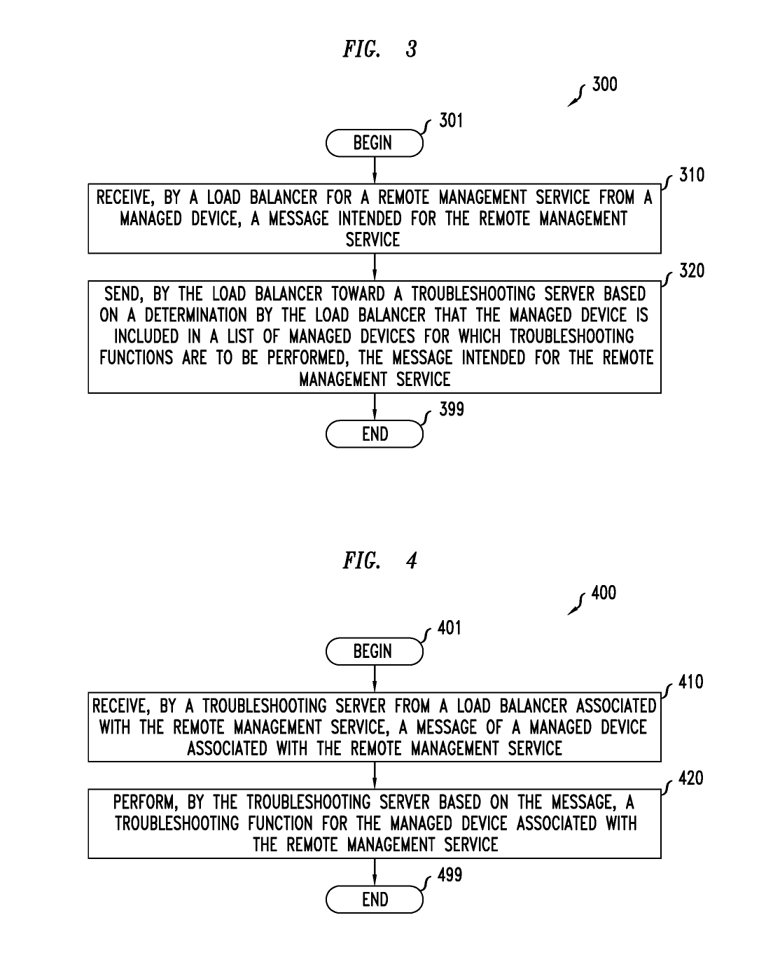

FIG. 3 depicts an embodiment of a method for use by a load balancer to support troubleshooting for a remote management service. It will be appreciated that the functions of method 300, although presented in FIG. 3 as being performed serially, may be performed contemporaneously or in a different order than as presented in FIG. 3. At block 301, method 300 begins. At block 310, the load balancer for the remote management service receives, from a managed device, a message intended for the remote management service. At block 320, the load balancer sends, toward a troubleshooting server based on a determination by the load balancer that the managed device is included in a list of managed devices for which troubleshooting functions are to be performed, the message intended for the remote management service. At block 399, method 300 ends. It will be appreciated that method 300 of FIG. 3 may be adapted to perform various other functions presented herein as being supported by a load balancer (e.g., LB 130 of FIG. 1 and FIG. 2) to handle troubleshooting for a remote management service.

FIG. 4 depicts an embodiment of a method for use by a troubleshooting server to support troubleshooting for a remote management service. It will be appreciated that the functions of method 400, although presented in FIG. 4 as being performed serially, may be performed contemporaneously or in a different order than as presented in FIG. 4. At block 401, method 400 begins. At block 410, the troubleshooting server receives, from a load balancer associated with the remote management service, a message of a managed device associated with the remote management service. At block 420, the troubleshooting server performs, based on the message, a troubleshooting function for the managed device associated with the remote management service. At block 499, method 400 ends. It will be appreciated that method 400 of FIG. 4 may be adapted to perform various other functions presented herein as being supported a troubleshooting server (e.g., a TS 123 of FIG. 1 and FIG. 2) to handle troubleshooting for a remote management service.

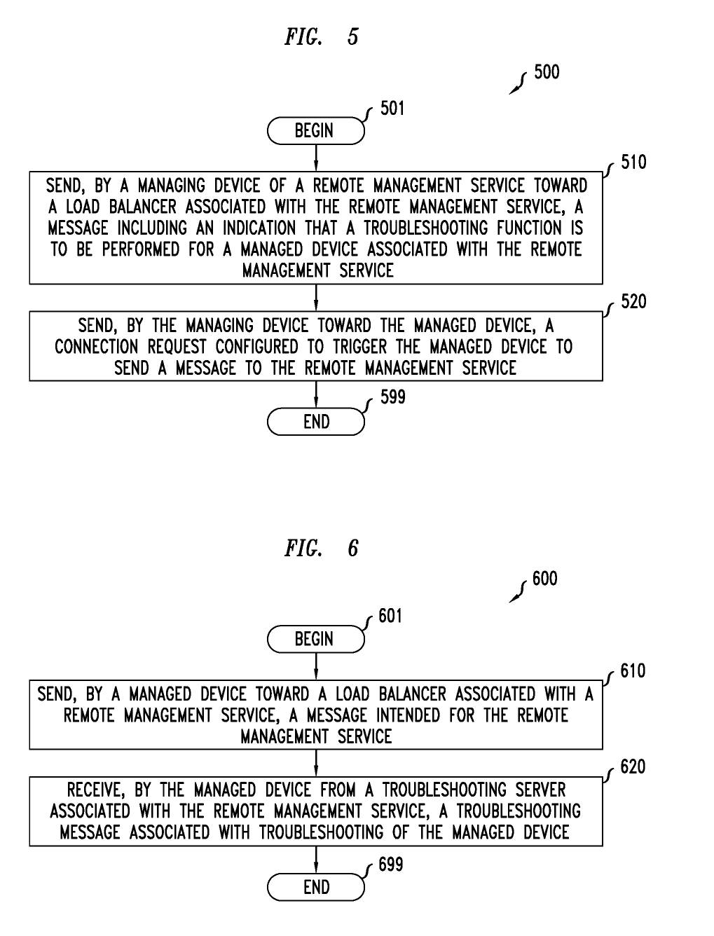

FIG. 5 depicts an embodiment of a method for use by a device management server to support troubleshooting for a remote management service. It will be appreciated that the functions of method 500, although presented in FIG. 5 as being performed serially, may be performed contemporaneously or in a different order than as presented in FIG. 5. At block 501, method 500 begins. At block 510, the managing device sends, toward a load balancer associated with the remote management service, a message including an indication that a troubleshooting function is to be performed for a managed device associated with the remote management service. At block 520, the managing device sends, toward the managed device, a connection request configured to trigger the managed device to send a message to the remote management service. At block 599, method 500 ends. It will be appreciated that method 500 of FIG. 5 may be adapted to perform various other functions presented herein as being supported by a device management server (e.g., a DMS 122 of FIG. 1 and FIG. 2) to handle troubleshooting for a remote management service.

FIG. 6 depicts an embodiment of a method for use by a managed device to support troubleshooting for a remote management service. It will be appreciated that the functions of method 600, although presented in FIG. 6 as being performed serially, may be performed contemporaneously or in a different order than as presented in FIG. 6. At block 601, method 600 begins. At block 610, the managed device sends, toward a load balancer associated with the remote management service, a message intended for the remote management service. At block 620, the managed device receives, from a troubleshooting server associated with the remote management service, a troubleshooting message associated with troubleshooting of the managed device. At block 699, method 600 ends. It will be appreciated that method 600 of FIG. 6 may be adapted to perform various other functions presented herein as being supported by a managed device (e.g., MD 110 of FIG. 1 and FIG. 2) to handle troubleshooting for a remote management service.

It will be appreciated that various embodiments of the RMS troubleshooting capability may provide various advantages or potential advantages. For example, various embodiment of the RMS troubleshooting capability may be configured to support troubleshooting for an RMS within a production environment of the RMS, thereby obviating the need for having an identical pre-production environment for use in troubleshooting issues or potential issues and, similarly, obviating the need to use an identical pre-production environment for use in troubleshooting issues or potential issues when often times a problem seen in the production environment is not seen in an identical pre-production environment and cannot be (or is at least difficult to) reproduce in an identical pre-production environment. For example, various embodiment of the RMS troubleshooting capability may be configured to support troubleshooting for an RMS within a production environment of the RMS with little or no impact to other devices of the RMS (e.g., obviating the need for managing devices, which may already be overloaded from handling traffic of managed devices, to enable troubleshooting functions such as verbose level tracing and network traffic capture (which may have significant impact on the performance of the managing devices) in order to troubleshoot issues or potential issues with certain managed devices). For example, various embodiment of the RMS troubleshooting capability may be configured to enable operators and support engineers to troubleshoot and debug issues or potential issues with MDs for an RMS within a production environment of the RMS. It will be appreciated that various embodiments of the RMS troubleshooting capability may provide various other advantages or potential advantages.

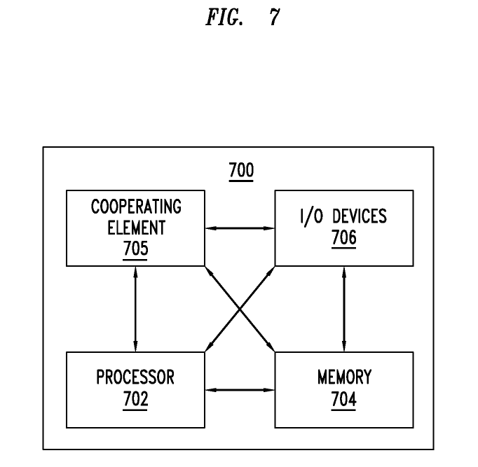

FIG. 7 depicts a high-level block diagram of a computer suitable for use in performing various functions described herein.

The computer 700 includes a processor 702 (e.g., a central processing unit (CPU), a processor having a set of processor cores, or the like) and a memory 704 (e.g., a random access memory (RAM), a read only memory (ROM), or the like). The processor 702 and the memory 704 are communicatively connected.

The computer 700 also may include a cooperating element 705. The cooperating element 705 may be a hardware device. The cooperating element 705 may be a process that can be loaded into the memory 704 and executed by the processor 702 to implement functions as discussed herein (in which case, for example, the cooperating element 705 (including associated data structures) can be stored on a non-transitory computer-readable storage medium, such as a storage device or other storage element (e.g., a magnetic drive, an optical drive, or the like)).

The computer 700 also may include one or more input/output devices 706. The input/output devices 706 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 700 of FIG. 7 may represent a general architecture and functionality suitable for implementing functional elements described herein, portions of functional elements described herein, or the like, as well as various combinations thereof. For example, computer 700 may provide a general architecture and functionality that is suitable for implementing one or more of an MD 110, an ACS 121, a DMS 122, a TS 123, the LB 130, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus configured to support troubleshooting in a remote management service, the apparatus comprising:
a processor and a memory communicatively connected to the processor, the processor configured to:
receive, by a load balancer for the remote management service from a managed device, a message intended for the remote management service; and
send, by the load balancer toward a troubleshooting server based on a determination by the load balancer that the managed device is included in a list of managed devices for which troubleshooting functions are to be performed, the message intended for the remote management service.

2. The apparatus of claim 1, wherein the processor is configured to:
determine, based on the message intended for the remote management service, an identity of the managed device; and
determine, based on the identity of the managed device, that the managed device is included in the list of managed devices for which troubleshooting functions are to be performed.

3. The apparatus of claim 1, wherein the processor is configured to:
receive, by the load balancer, a message including an indication that a troubleshooting function is to be performed for the managed device; and
add, by the load balancer based on the indication that the troubleshooting function is to be performed for the managed device, an identifier of the managed device to the list of managed device for which troubleshooting functions are to be performed.

4. The apparatus of claim 3, wherein the processor is configured to receive the message, including the indication that the troubleshooting function is to be performed for the managed device, from the remote management service, the troubleshooting server, or an operations support system.

5. The apparatus of claim 1, wherein the processor is configured to:
receive, by the load balancer, a message including an indication that troubleshooting of the managed device is complete; and
remove, by the load balancer based on the indication that troubleshooting of the managed device is complete, the identifier of the managed device from the list of managed device for which troubleshooting functions are to be performed.

6. The apparatus of claim 5, wherein the processor is configured to receive the message, including the indication that troubleshooting function of the managed device is complete, from the remote management service, the troubleshooting server, or an operations support system.

7. The apparatus of claim 1, wherein the troubleshooting server is configured to perform at least one of a verbose tracing function or a debug function.

8. The apparatus of claim 1, wherein the remote management service comprise an Automatic Configuration Service, wherein the management server comprises an Automatic Configuration Server (ACS), wherein the managed device comprises a network equipment (NE) or a customer premises equipment (CPE), wherein the message is a TR-069 message.

9. An apparatus configured to support troubleshooting in a remote management service, the apparatus comprising:
a processor and a memory communicatively connected to the processor, the processor configured to:
receive, by a troubleshooting server from a load balancer associated with the remote management service, a message of a managed device associated with the remote management service; and
perform, by the troubleshooting server based on the message, a troubleshooting function for the managed device associated with the remote management service.

10. The apparatus of claim 9, wherein the troubleshooting function comprises at least one of a verbose tracing function, a network traffic capture function, or a debug function.

11. The apparatus of claim 9, wherein, to perform the troubleshooting function for the managed device, the processor is configured to:
send, by the troubleshooting server, a first message toward the managed device; and
receive, by the troubleshooting server, a second message from the managed device.

12. The apparatus of claim 9, wherein the processor is configured to:
send, by the troubleshooting server toward the load balancer, a message including an indication of an identity of the managed device and an indication that troubleshooting is to be performed for the managed device.

13. The apparatus of claim 9, wherein the processor is configured to:
send, by the troubleshooting server toward the load balancer, a message including an indication of an identity of the managed device and an indication that troubleshooting of the managed device is complete.

14. The apparatus of claim 9, wherein the remote management service comprise an Automatic Configuration Service, wherein the managed device comprises a network equipment (NE) or a customer premises equipment (CPE), wherein the message of the managed device is a TR-069 message.

15. An apparatus configured to support troubleshooting in a remote management service, the apparatus comprising:
a processor and a memory communicatively connected to the processor, the processor configured to:
send, by a managing device of the remote management service toward a load balancer associated with the remote management service, a message including an indication that a troubleshooting function is to be performed for a managed device associated with the remote management service; and
send, by the managing device toward the managed device, a connection request configured to trigger the managed device to send a message to the remote management service.

16. The apparatus of claim 15, wherein the processor is configured to:
send, by the managing device toward the load balancer, a message including an indication that troubleshooting function of the managed device is complete.

17. The apparatus of claim 16, wherein the processor is configured to:
receive, by the managing device from the load balancer, a message of the managed device.

18. The apparatus of claim 15, wherein the remote management service comprise an Automatic Configuration Service, wherein the managed device comprises a network equipment (NE) or a customer premises equipment (CPE), wherein the connection request is sent using a TR-069 message.

19. An apparatus configured to support troubleshooting in a remote management service, the apparatus comprising:
a processor and a memory communicatively connected to the processor, the processor configured to:
send, by a managed device toward a load balancer associated with the remote management service, a message intended for the remote management service; and
receive, by the managed device from a troubleshooting server associated with the remote management service, a troubleshooting message associated with troubleshooting of the managed device.

20. The apparatus of claim 19, wherein the processor is configured to:
send, by the managed device toward the troubleshooting server, a troubleshooting response message associated with troubleshooting of the managed device.

21. The apparatus of claim 19, wherein the processor is configured to:
receive, by the managed device from a managing device of the remote management server, a connection request, wherein the message intended for the remote management service is sent responsive to the connection request.

22. The apparatus of claim 19, wherein the remote management service comprise an Automatic Configuration Service, wherein the managed device comprises a network equipment (NE) or a customer premises equipment (CPE), wherein the message intended for the remote management service is a TR-069 message.
